(19) United States
(12) Patent Application Publication
(10) Pub. No.: US 2016/0194548 A1
(43) Pub. Date: Jul. 7, 2016

(54) Method and Use of a Composition for Sand Consolidation in Hydrocarbon Wells

(71) Applicant: WELLCEM AS, Trondheim (NO)

(72) Inventors: Minli Xie, Sandnes (NO); Alam Maqsad, Stavanger (NO)

(73) Assignee: Wellcem AS, Trondheim (NO)

(21) Appl. No.: 14/909,413

(22) PCT Filed: Aug. 6, 2014
(86) PCT No.: PCT/NO2014/050140

§ 371 Date: Feb. 1, 2016

(30) Foreign Application Priority Data
Aug. 15, 2013 (NO) 20131116

(51) Int. Cl. C09K 8/56; E21B 43/16

(52) U.S. Cl. CPC C09K 8/56; E21B 43/16

(57) ABSTRACT

A method is for consolidating particulate matter in a well. The method comprises injecting a composition into a sand bearing formation. The composition comprises a curable non-aqueous, homogeneous liquid, an initiator for heat induced production of free radicals, a pot life extending inhibitor for stabilization of free radicals, and optionally an accelerator and optionally a filler. The non-aqueous, homogeneous liquid further comprises an at least partially unsaturated prepolymer including at least one of polyester and epoxy vinyl ester, and at least one vinyl or allyl containing monomer. The method further comprises subsequently injecting an aqueous, non-aqueous liquid or a gas for re-establishing permeability of the formation and letting the composition cure by free radical polymerization in the sand bearing formation at a temperature of 0-150° C. to form a cured sand consolidating material.

### FIELD OF THE INVENTION

The present invention relates to a method for consolidation of sand in hydrocarbon wells. More particularly, the invention relates to a method and the use of a composition that provides for sand consolidation at temperatures from 0-150° C. and improved control over pot life and curing time.

BACKGROUND OF THE INVENTION AND PRIOR ART

When oil is produced from a well, sand is often present in the produced fluid. This is a particularly prevalent phenomenon when the reservoirs are composed of poorly consolidated rock such as sandstone.

Because of the abrasive nature of sand, its presence in the produced fluid can cause several problems, such as early failure of pumps, and erosion of tubing, valves, chokes, pipe bends and other mechanical equipment used in the production of petroleum. Casing placed in the well also have the potential to collapse if the reservoir rock settles due to the voids left by sand that has migrated into the produced fluid. Also, the disposal of contaminated sand and associated handling of the sand can incur significant costs. The annual cost in the petroleum industry associated with the problems connected to sand production is in the range of billions of dollars.

Several factors can affect the sand production in so called “weak formations”. Reservoir pressure depletion, rock stresses, and changes in flow rate and changes in water cut are all factors that can have an implication on the amount of sand produced from a well.

To reduce or minimize the amount of sand produced from a well, several techniques are known in the art. Such techniques are mechanical, chemical or a combination thereof.

Mechanical means for controlling influx of sand to the produced fluid usually consist of methods for making mechanical obstructions through which sand cannot pass, in principle acting as a filter. Placement of finely meshed screens, slotted liners and so called “gravel packs” are commonly used. A gravel pack is a mass of gravel of a specific size to prevent passage of sand. The mechanical devices are usually installed in the wellbore adjacent to the producing interval.

A problem associated with the use of mechanical means for sand control is the potential plugging that can occur of screens, gravel packs and liners. The productivity of oil can decline sharply when this happens.

A non-mechanical method that can be used as a sand control measure is to maintain the well flowing at the so-called “MSFR” which means the maximum sandfree rate. This is done by obstructing the flow, and in this way minimizing the hydrodynamic forces that act on the sand. This reduces the amount of sand that can be carried into the wellbore. However, maintaining the flow at or below the MSFR can be highly uneconomical.

Chemical means for sand control is commonly based on injecting a polymeric material that has the effect of binding the sand grains together. Chemical methods are in many cases preferred over mechanical means. The reason for this is that the wellbore is left free of obstructions and because of the immobilization of the sand that takes place at a greater distance from the wellbore, where the hydrodynamic forces tend to be smaller. Additionally, chemical treatments can be carried out in tubingless wells and without pulling the completion string.

Chemical treatments are usually placed by using a three step process. In the first step, a liquid polymeric material is injected into the well and into the formation wherein the second step the permeability of the formation is re-established by injecting a secondary fluid that opens up channels in the polymeric material. Finally, the polymeric material is cured, either by itself, or by injecting an initiator or activator into the formation. According to this process, the purpose of the polymeric material is to coat the sand to make the sand particles adhere to each other. After chemical sand consolidation, permeability of the rock will seldom return to its “un-treated” value. The permeability is usually reduced by 10 to 40 percent of the initial values.

Common polymer chemistries that are used for sand consolidation include epoxies, furans, polyesters, polyols and phenolics. The resins are hardened by the use of catalysts that initiate polymerization. The catalysts are either mixed with the resins at the surface, or are injected as a second step when the polymerizable resin has been placed in the formation. For the furan based resins, the initiator/catalyst is usually injected into the formation first.

U.S. Pat. No. 4,427,069 discloses a sand consolidation material comprising furfuryl alcohol oligomer resin cured with lewis acids such as aluminium chloride. The catalyst is first injected into the formation followed by the oligomeric resin which then polymerizes and consolidates the sand.

A problem with the use of furfuryl alcohol resins is that the initiator cannot be mixed with the resin at the surface, as the polymerization reactions are very rapid and unpredictable.

U.S. Pat. No. 5,492,177 describes a method for sand consolidation, where the sand consolidating composition is comprised of an allyl monomer, a diluent and an initiator. The composition is cured in the formation when it is exposed to an elevated temperature of 73° C.

The general problem with sand consolidation methods of the prior art, is the need for elevated temperatures to effect curing, generally above 70° C., and the lack of exact control of the pot life and curing time of the polymeric sand consolidation materials.

The term “pot life” is to be understood as the time after the addition of catalyst/initiator wherein the material retains low enough viscosity for it to be applied satisfactorily, i.e. the material has a sufficiently low viscosity for being pumped into a formation. The term “curing time” is the time from the addition of catalyst/initiator until the polymeric material has fully cured into a cross-linked mass.

The applicant has previously patented a means and a method for the preparation of sealings in oil and gas wells. This is described in U.S. Pat. No. 6,082,456. The composition described in said patent provides a means for sealing zones with a rapid cure, low shrinkage and controlled setting time.

### SUMMARY OF THE INVENTION

The invention has for its object to remedy or to reduce at least one of the drawbacks of the prior art, or at least provide a useful alternative to prior art.

The object is achieved through features which are specified in the description below and in the claims that follow.

It has surprisingly been found that the material previously patented by the applicant for well-sealing purposes is also suitable for use as a sand consolidation material, providing several advantages over the prior art.

The main object of the invention is to provide an improved method for carrying out sand consolidation, where the resulting cured polymeric sand consolidation material provides higher strength, lower shrinkage and a more controlled curing time than in prior art methods.

The object is achieved by a method comprising a first step where a sand-consolidating material comprising a prepolymer in the form of an at least partially unsaturated polyester or epoxy vinyl ester, at least one vinyl containing monomer, an inhibitor, an initiator, and optionally a filler and/or accelerator and other additives is injected into the formation.

The second step of the method comprises injecting an aqueous-, non-aqueous liquid or gaseous means into the formation for the purpose of re-establishing the permeability of the formation.

The third step of the method comprises letting the composition of the first step cure by free radical polymerization in the sand bearing formation at a temperature of 0-150° C. to form a cured sand consolidating material.

The selection of the amount of initiator, accelerator and inhibitor relative to the amount of prepolymer yields control over the desired curing time and pot life of the composition as determined by the formation temperature. A filler material can also be included in the composition for adjusting rheology, density and mechanical properties.

In a first aspect the invention relates to a method for consolidating particulate matter in a well where the method comprises a first step where a composition is injected into a sand bearing formation, where the composition comprises a curable non-aqueous, homogeneous liquid, an initiator for heat induced production of free radicals, a pot life extending inhibitor for stabilization of free radicals, and optionally a filler or accelerator wherein said non-aqueous, homogeneous liquid further comprises an at least partially unsaturated prepolymer selected from the group consisting of polyester and epoxy vinyl ester, and at least one allyl- or vinyl-containing monomer.

During the first step, the composition is mixed at the surface to achieve the desired curing time as determined by the reservoir conditions. This is done by proper selection of the amounts of initiator, inhibitor and optionally accelerator, as described in U.S. Pat. No. 6,082,456. A filler material is alternatively also mixed into the composition.

The viscosity of the non-polymerized composition should preferably be made up to be in the range of 5 to 100 cP at downhole temperature conditions.

The composition is subsequently pumped into the zone of interest through work string (tubing, coiled tubing etc.). The zone of interest could for instance be the near bottom hole zone. The composition is then squeezed into the sand bearing formation around the wellbore.

The first step is followed by a second step where an aqueous, non-aqueous liquid or a gas is injected to re-establish permeability of the formation. The second step displaces the composition further into the formation.

The purpose of the second step is to open up channels in the polymerizable mass in which formation fluid can flow and enter the wellbore. Without the second step, the material have the potential of curing in situ and would then effectively act as a sealant material, counter to the purpose of the invention which is to prevent sand from flowing into the wellbore.

During the second step, the polymerizable material coats the unconsolidated sand grains, providing adherence between the sand particles and subsequently insures that the sand particles are immobilized.

The second step is followed by a third step wherein the composition is allowed to cure by free radical polymerization subject to the reservoir conditions. The composition is particularly suitable for use at reservoir temperatures between 0-150° C.

After the third step, the well is allowed to flow. The flow rates and sand production rates are recorded to establish the efficacy of the treatment.

The first step can optionally be preceded by a pre-treatment step. The pre-treatment step comprises running injectivity tests, for instance by pumping water at a rate of 1-5 Bbl/min and recording the injectivity parameters.

After the injectivity test, aqueous or non-aqueous fluid can be injected into the formation for the purpose of cleaning the perforation channels and for the purpose of pushing the formation fluid away from the near wellbore zone and for the purpose of enhancing the bonding between sand and curable liquid composition. The fluid is preferably a formation-compatible fluid, such as a saline aqueous solution. The fluid can also contain agents, such as surfactants, for the purpose of changing the wetting characteristics of the sand grains prior to the first step of the method.

A preflush solution suitable for use with the present method comprises a combination of an aqueous liquid, a coupling agent and optionally, a surfactant. The surfactant used can selected form any class of surfactants, comprising non-ionic surfactants, anionic surfactants, cationic surfactants, amphoteric surfactants, hydrotropic surfactants or combinations thereof. The coupling agent is preferably a silane coupling agent selected from the group comprising vinyltrimethoxy silane, 3-methacryloxy propyltrimethoxy silane, aminoalkyl silane, and combinations thereof. The silane coupling agent is usually present in the range of 0, 1 to 4 weight percent of the sand consolidation material.

The prepolymer used in the first step of the method can be selected to be a polyester, epoxy vinyl ester or a mixture of these. To achieve the necessary cross-linking, double bonds must be present in the prepolymer. Unsaturated ester-type prepolymers can for example be used.

Examples of commercially available prepolymers suitable for use with the present method are Norpol 68-00 DAP and Norpol 47-00 (Jotun AS, Norway).

According to the present invention, the first step of the method can further include selecting the monomeric component of the composition from a group comprising styrene, vinyl toluene and acrylate compounds.

Due to offshore safety regulations, vinyl compounds that exhibit low flash points are usually avoided. An example of such a compound is styrene with a flash point of 31° C.

For this reason compounds such as vinyl toluene (fp 53° C.), t-butylstyrene (fp. 81 ° C.), diethylene glycol dimethacrylate (fp. 148 ° C.), other acrylate compounds, diallylphtalate, or mixtures of these are preferred.

Acrylate compounds can be selected from the group comprised of 2-hydroxy ethyl methacrylate and 2-hydroxy propyl methacrylate.

An allylic compound such as diallylphtalate can also be mixed into the composition with any of the monomers as described above.

Furthermore, the composition as described in the first step of the method, the prepolymer may be selected to be present in an amount of not more than 90 parts by weight, the monomer is selected present in an amount of not more than 90 parts by weight.

The initiator may be selected among common radical initiators such as organic peroxides. Examples of such peroxides are benzoyl peroxide, t-butyl-peroxy-3,3,5-trimethylhexanoate, t-butyl-cumylperoxide and di-t-butylperoxide. The amount of the initiator is selected according to the temperature conditions of the formation as a means for achieving the desired pot-life and curing time. The initiator is usually present in the range of 0.1-5 parts per weight of the composition.

The inhibitor used in the composition is selected from radical inhibitors, commonly known to a person skilled in the art. An example of a preferred inhibitor is parabenzoquinone, as this inhibitor is particularly effective at elevated temperatures. Other inhibitors that be used are hydroquinones that form quinones when reacting with dispersed oxygen. The quantity of the inhibitor is selected based on the desired pot life and curing time of the composition, and is usually in the range of 0.02 to 2 parts per weight of the composition.

The initiator and optionally inhibitor and/or accelerator are preferably selected in an amount so that a curing time in the range of 30 minutes to 24 hours is achieved at a temperature range of 0-150° C. in the formation. More preferably, the curing time is between 2 to 6 hours at a temperature range of 0-150° C. in the formation.

The accelerator may be selected among common accelerators for free radical reactions as would be known to a person skilled in the art. Examples of such accelerators are transition metal based accelerators such as the pure elements and compounds of cobalt, iron, copper and manganese. Examples of organic accelerators are amides and amines such as N,N-dimethyl-p-toluidine.

The composition can further comprise a filler. The purpose of the filler is to control the rheological properties of the composition, improving the mechanical properties and for adjusting of density of the composition if required. The filler can be any material, but a requirement is that the filler is compatible with the curing temperature of the composition and that the filler is chemically inert. The filler is typically present in an amount constituting 10-45 volume percent of the composition. Examples of filler materials are materials that are selected from the group comprising of oxides, such as trimanganese tetroxide, carbonates such as calcium carbonate, sulfates such as barium sulphate and minerals such as wollastonite. The filler can also be silicic materials, such as glass beads, hollow glass spheres, fumed silica or aerogels.

The composition as described in the first step of the said method can be used as a sand consolidation material in general, without following the method as previously described.

To further illustrate the present invention, the following example is set forth:

### EXAMPLE 1

Wet sand was packed as a homogeneous sand pack (20-40 mesh size) in a 10 cm long core of one inch diameter. The approximate porosity of the sand was 37%.

The core was flushed with fresh water at a flow rate of 50 ml/min. The pore volume of the core was approximately 15 ml. No injection pressure was observed.

A preflush solution comprising of 1 wt % of a surfactant and 1 wt % of a silane coupling agent was subsequently injected at a flow rate of 10 ml/min at a volume corresponding to approximately 5 pore volumes.

The sand consolidating composition (1.03 SG, 60 cP viscosity) was then injected at a flow rate of 5 ml/min with a volume of composition corresponding to approximately 2 pore volumes.

The core was then subsequently flushed with 12 pore volumes fresh water at a flow rate of 10 ml/min.

The core was then placed in a water bath at 70° C. for 3 hours to cure the sand consolidating composition. After the cure was completed, the core was again flushed for recording the resulting permeability.

The resulting mass of sand was solid but permeable to fluid flow.

The consolidated mass of sand was tested for unconfined compressive strength. The unconfined compressive strengths ranged from 600 to 1500 psi depending on post flush volume and the desired post treatment permeability.

1. A method for consolidating particulate matter in a well, said method comprising:
A—injecting a composition into a sand bearing formation, where the composition comprises a curable non-aqueous, homogeneous liquid, an initiator for heat induced production of free radicals, and a pot life extending inhibitor for stabilization of free radicals, wherein said non-aqueous, homogeneous liquid further comprises an at least partially unsaturated prepolymer selected from the group consisting of polyester and epoxy vinyl ester, and at least one vinyl or allyl containing monomer;
B—subsequently inject injecting a aqueous, non-aqueous liquid or a gas for reestablishing permeability of the formation;
C—letting the composition of step A cure by free radical polymerization in the sand bearing formation at a temperature of 0-150° C. to form a cured sand consolidating material.

2. The method according to claim 1, wherein step A further comprises selecting the monomer from a group comprising styrene, vinyl toluene and acrylate compounds.

3. The method according to claim 2, wherein the monomer additionally comprises diallylphthalate monomer.

4. The method according to claim 2, wherein said acrylate compounds are selected from a group comprised of 2-hydroxy ethyl methacrylate and 2-hydroxy propyl methacrylate.

5. The method according to claim 1, wherein said prepolymer is selected to be present in an amount of not more than 90 parts by weight, the monomer is selected present in an amount of not more than 90 parts by weight, the initiator is selected to be present in an amount of 0.1-5 parts by weight and the inhibitor is selected to be present in an amount of 0.02-2 parts by weight.

6. The method according to claim 1, wherein step A further comprises selecting the filler from a group comprised of oxides, sulfates, minerals, silicic materials or combinations thereof.

7. The method according to claim 1, wherein step A further comprises selecting glass beads as the filler.

8. The method according to claim 1, wherein step C further comprises curing the composition in the range of 30 minutes to 24 hours at 0-150° C.

9. The method according to claim 1, further comprising, prior to step A, injecting a liquid means into the formation for displacing fluids present in the formation.

10. The method according to claim 9, further comprising injecting an aqueous solution as the liquid means.

11. The method according to claim 9, further comprising addition of surface active agents to the liquid means.

12. The method according to claim 11, further comprising selecting the surface active agent from a group comprising anionic, cationic, nonionic, amphoteric and hydrotropic surfactants or combinations thereof.

13. The method according to claim 9, further comprising adding a silane coupling agent to the liquid means.

14. The method according to claim 13, comprising selecting the silane coupling agent from the group comprising vinyltrimethoxy silane, 3-methacryloxy propyltrimethoxysilane, aminoalkyl silane and combinations thereof.

15. The method of claim 8, wherein step A further comprises selecting the accelerator from the group comprised of transition metal compounds.

16. The method of claim 18, wherein step A further comprises selecting the accelerator from the group comprised of amides and amines.

17. The method of claim 18, wherein step A further comprises selecting N,N-dimethyl-p-toluidine as the accelerator.

18. The method of claim 1, wherein the composition of step A further comprises an accelerator.

19. The method of claim 1, wherein the composition of step A further comprises a filler.

20. A method for consolidating particulate matter in a well, said method comprising:
A—injecting a composition into a sand bearing formation, where the composition comprises a curable non-aqueous, homogeneous liquid, an initiator for heat induced production of free radicals, a pot life extending inhibitor for stabilization of free radicals, and an accelerator and a filler wherein said non-aqueous, homogeneous liquid further comprises an at least partially unsaturated prepolymer selected from the group consisting of polyester and epoxy vinyl ester, and at least one vinyl or allyl containing monomer;
B—subsequently injecting a aqueous, non-aqueous liquid or a gas for re-establishing permeability of the formation;
C—letting the composition of step A cure by free radical polymerization in the sand bearing formation at a temperature of 0-150° C. to form a cured sand consolidating material.
